(19) United States
(12) Patent Application Publication
(10) Pub. No.: US 2018/0017328 A1
(43) Pub. Date: Jan. 18, 2018

(54) ROTATING FURNACE INERTING

(71) Applicant: Air Liquide Industrial U.S. LP, Houston, TX (US)

(72) Inventor: Stewart C. JEPSON, Berwyn, IL (US)

(21) Appl. No.: 15/207,686

(22) Filed: Jul. 12, 2016

(51) Int. Cl. F27D 3/16; F27B 7/10; F27B 7/34; F27D 7/02; F27B 7/06; F27B 7/36; F27B 7/20

(52) U.S. Cl. CPC F27D 3/16; F27B 7/362; F27B 7/10; F27B 7/2083; F27D 7/02; F27B 7/06; F27B 7/34; F27B 2007/367; F27D 2003/167; F27D 2007/023

(57) ABSTRACT

A gas inerting system and method is provided. This system includes a rotary melting furnace with a furnace barrel, a burner, and a charge of metal to be melted; and an injection manifold with a plurality of injection orifices. The burner is configured to produce a flame directed into the furnace barrel, and the plurality of injection orifices are configured to disperse inert gas streams into the furnace barrel, into an inerting region between the burner flame and the charge of aluminum. The metal to be melted may be aluminum. The method of inerting includes rotating the rotary furnace and introducing heat into the furnace barrel by generating the flame, thereby beginning a melt cycle, then introducing the inert gas streams into an inlet to the injection manifold, thereby directing the inert gas streams through the injection orifices and into the inerting region, after a predetermined condition has been met.

### BACKGROUND

Aluminum scrap today is commonly melted in rotary furnaces. Aluminum dross, or the skimmings from reverberatory melting furnaces, is also commonly processed in rotary furnaces. A rotary furnace for melting aluminum scrap or dross is shown in FIG. 1. The fossil fuel-fired burner fires directly into the rotating drum. Rotary furnace melting is a batch process.

Burner products of combustion (CO2 and H2O), along with any excess O2 in the furnace atmosphere (from the burner itself or from infiltration air) can react with Aluminum to form aluminum oxide. This is referred to as “melt loss” or “fire loss”, and it reduces % yield (% recovery), and it has long been recognized as an extra cost and loss of profitability for aluminum melting operations. While the aluminum charge is still solid, its tendency to oxidize in the presence of O2, CO2 and H2O is less. As the aluminum heats up, and especially when it becomes molten, the oxidation rate greatly increases.

Dross is a mixture of aluminum oxide and aluminum metal. When skimming the reverberatory furnace into the dross pan, some aluminum metal is always entrapped with the skimmed oxides. Secondary aluminum processors melt the dross in rotary furnaces to recover the aluminum, which separates from the oxides when melted, with the aid of salt flux.

Usually rotary furnaces are utilized to melt lighter gauge charge materials, such as machine chips or shreds, and to process dross. Typically the burner is not aimed to impinge directly on the charge materials, the burner is instead aimed either parallel to the charge or at a slightly upward angle, in order to minimize aluminum melt loss (oxidation) from direct flame impingement. However, even without direct flame impingement, when melting aluminum in a rotary furnace, some of the aluminum metal is oxidized. Melt losses can be higher in rotary furnaces than in other types of melt furnaces (such as well-charged reverberatory furnaces) since the aluminum metal is directly exposed to the burner products of combustion (even without flame impingement), and with the furnace barrel rotation there is more “turnover” and exposure of the aluminum to the combustion atmosphere. Melt loss can range from roughly 0.5% to as much as 5% when melting aluminum (Das, February 2006).

Aluminum melt losses are typically higher, for lighter gauge types of scrap such as machine chips or shreds, owing to the higher surface area to mass ratio. When processing dross, melt loss can also be high, since the aluminum metal in dross is often in the form of fines, with very high surface area to mass ratio. However it is more difficult to accurately determine aluminum melting loss when processing dross, since the aluminum content of the incoming dross material (mixture of oxides and aluminum metal) is often not precisely known. So in some cases, when processing dross, the actual aluminum melting (oxidation) loss may be higher than what is thought or assumed.

During fuel-fired rotary furnace melting of aluminum, it has been observed that aluminum oxidation takes place mostly during a certain phase of the batch melting process (Jepson and Kim, TMS 2016). In this study, flue gas analysis was utilized to calculate instantaneous aluminum oxidation rates, throughout the rotary furnace batch melt process. It was found that most of the aluminum oxidation occurs near the end of the heat, during the “breakdown” phase, where the solid aluminum becomes molten. Typically, for most scrap types, this phase occurs near the end of the melt cycle, but for some types of melts and processes it can occur earlier in the cycle. Typically, this critical process phase lasts for approximately 10 minutes, +/−5 minutes.

While the furnace charge is still solid, during furnace rotation, the solid charge pieces tend to “climb the walls”, with a slight tumbling action. After the charge has completely turned to liquid, it no longer climbs the walls. Operators can determine when this “breakdown” transition occurs, by monitoring the amp draw on the furnace rotation motor. There is typically a significant reduction in rotation motor amp draw when the load has fully melted from solid to liquid. In many shops today the operators utilize this parameter to determine when melting is complete, without opening the furnace door to examine visually. Opening the door takes time, and contributes to energy loss and additional contact with ambient air and O2.

During the “breakdown” phase, when the solid aluminum is transitioning to molten, one can often observe a “slushy” mix of solid and molten aluminum climbing the furnace wall during rotation. This increased surface area exposure of molten/solid aluminum contributes to increased aluminum oxidation losses. In some cases, one can see the aluminum oxidizing (sparkles) as it climbs the walls during rotation.

### SUMMARY

A gas inerting system is provided. This system includes a rotary melting furnace with a furnace barrel, a burner, and a charge of metal to be melted; and an inert gas injection manifold with a plurality of injection orifices. The burner is configured to produce a flame directed into the furnace barrel, and the plurality of injection orifices are configured to disperse inert gas streams into the furnace barrel, into an inerting region between the burner flame and the charge of aluminum. The metal to be melted may be aluminum. The injection manifold may have a semicircular shape, wherein the plurality of injection orifices is generally equidistant from the burner.

A gas inerting method includes rotating the rotary furnace and introducing heat into the furnace barrel by generating the flame, thereby beginning a melt cycle, then introducing the inert gas streams into an inlet to the injection manifold, thereby directing the inert gas streams through the injection orifices and into the inerting region, after a predetermined condition has been met. The predetermined condition may be at the start of a breakdown phase, at a predetermined time after the beginning of the melt cycle, and/or at a predetermined time prior to the end of the melt cycle.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation (side view) of a rotary furnace for melting aluminium.

FIG. 2 is a schematic representation (end view) of a rotary furnace for melting aluminium, incorporating one embodiment of the present invention.

FIG. 3 is a schematic representation (side view) of a rotary furnace incorporating one embodiment of the present invention.

FIG. 4 is a schematic representation (end view) of a rotary furnace illustrating the melting charge climbing up the sidewalls.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure

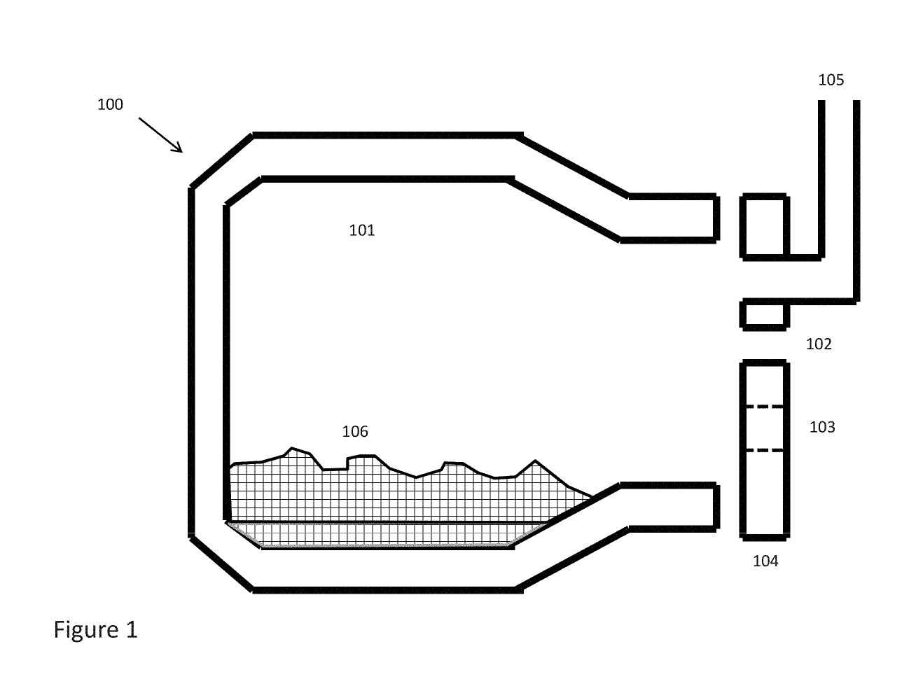

Turning to FIG. 1, a rotary melting furnace 100 includes a furnace barrel 101, a burner 102, an injection manifold 103, a door 104, a flue 105, and a charge of metal to be melted 106.

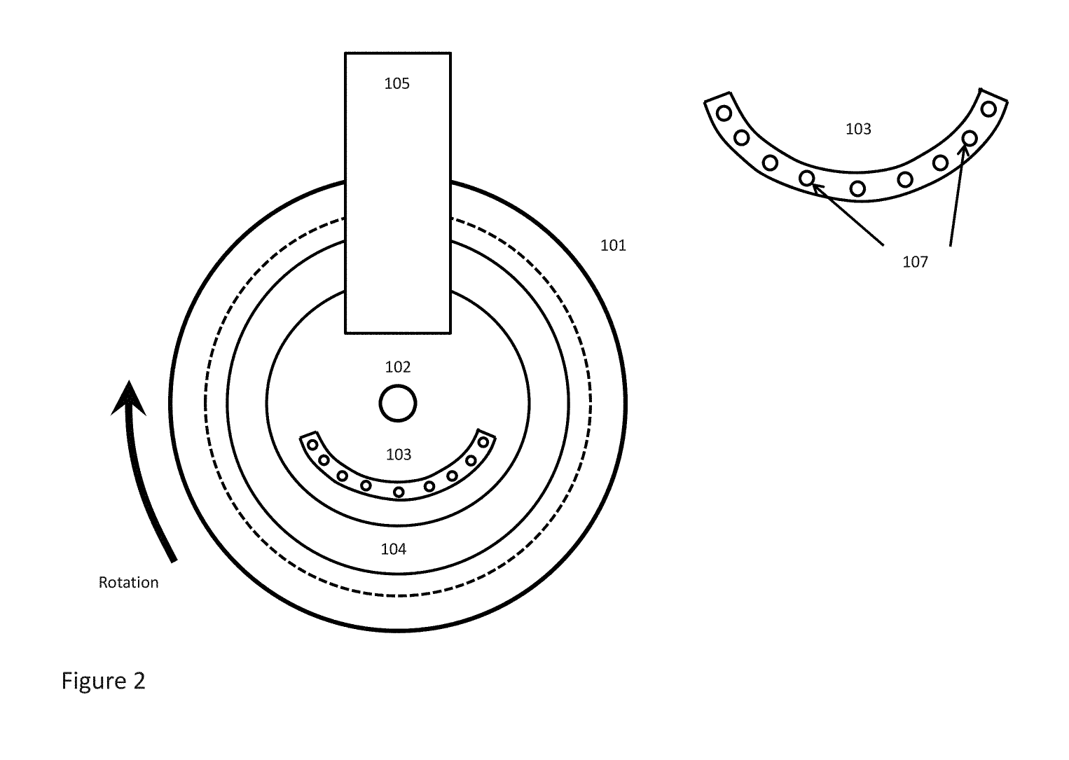

FIG. 2 illustrates the view as seen from the end of the rotary melting furnace 100. The shape of the injection manifold 103 can be seen to contour to the general shape of the furnace barrel 101. The shape of the injection manifold 103 can be seen to be of a general semicircular shape that locates the multiple injection orifices 107 at roughly equal distance from the burner 102.

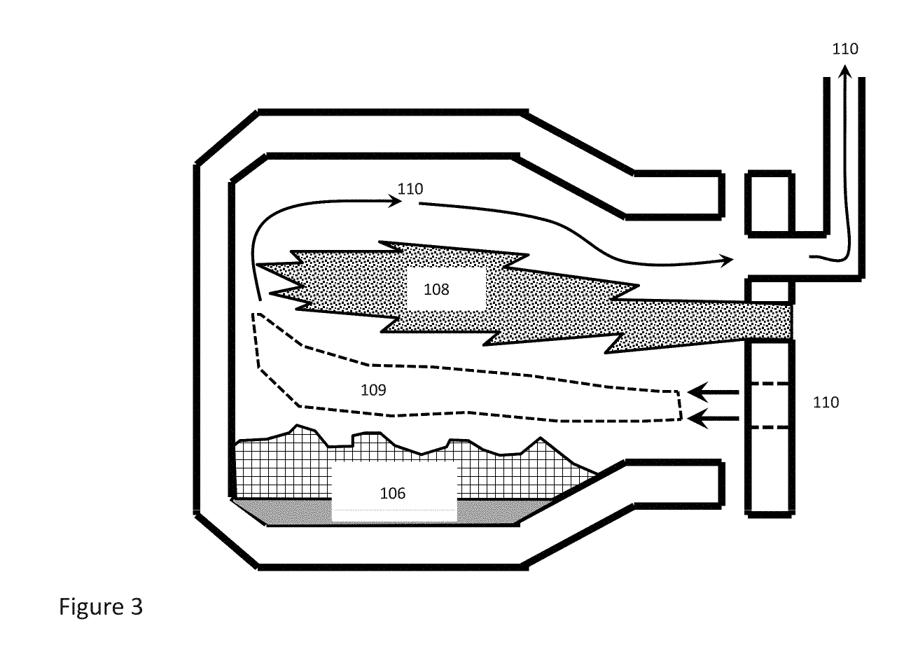

FIG. 3 illustrates a side view of the rotary melting furnace 100 while utilizing the present invention. The burner 102 is configured to produce a flame 108 that propagates into the furnace barrel 101. The burner 102 may be configured to direct the flame either parallel to the charge of metal to be melted 106, or at a slight upward angle. At the appropriate time in the cycle, discussed below, inert gas 110 is injected into the injection manifold 103 and exits the multiple injection orifices 107, thereby entering the furnace barrel 101. The injection manifold 103 is configured to direct the inert gas 110 into an inerting region 109 that is located between the burner flame 108 and the charge of metal 106. The inert gas 110 then follows the natural circulation of the rotary melting furnace 100, and exits the flue 105 along with the exhaust gases from the flame 108. The inert gas 110 may be nitrogen. The inert gas 110 may be nitrogen with a purity of greater than 80%, preferably with a purity greater than 90%, more preferably greater than 95%.

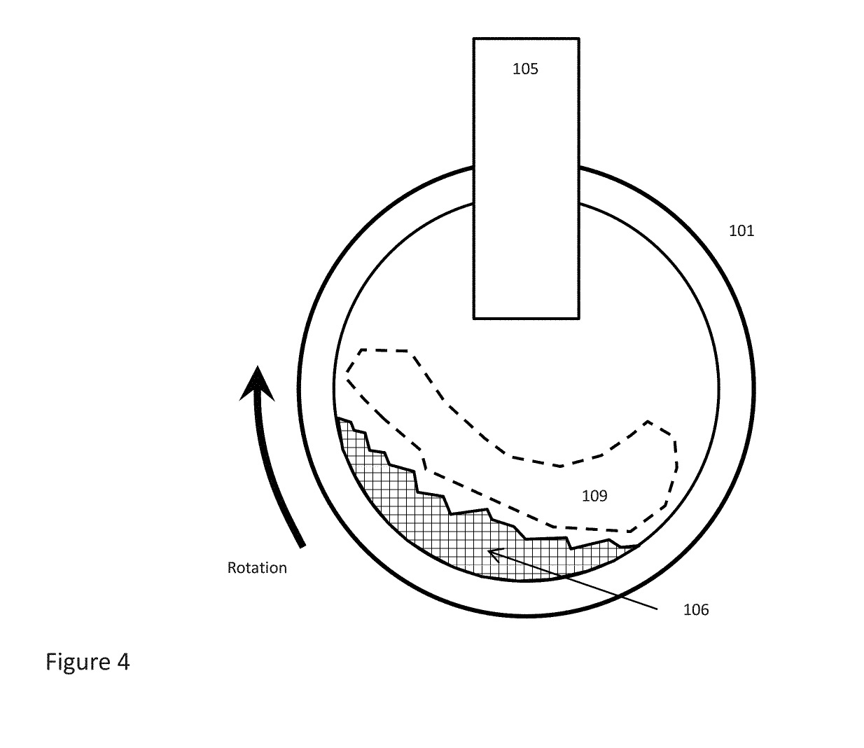

This system provides an economical and effective method to utilize a nitrogen gas “curtain” shroud (inerting region 109) to inert the aluminum surface 106 as it breaks down from solid to liquid, to reduce oxidation losses, during rotary furnace 100 aluminum melting. In one embodiment, a U-shaped nitrogen gas injector 103, is positioned underneath the burner 102, to inject nitrogen gas following the profile of the furnace side walls and bath/charge surface 106. As indicated in FIG. 4, in this manner, not only the bath/charge surface 106 can be protected, but also the sidewalls where the melting aluminum climbs during furnace rotation. This climbing action exposes more Al to the furnace atmosphere.

To get the most benefit from the nitrogen gas, and to optimize cost, this nitrogen injection can be timed so that it is only utilized during a predetermined period, or after a predetermined condition has been met, such as entering the breakdown phase, for roughly 10 minutes. It may not be economically feasible to inject nitrogen gas throughout the entire heat. The breakdown phase can be anticipated by monitoring furnace rotation motor amp draw, and/or flue gas temperature, or total cycle time, or total cumulative BTU energy input per lb of charge, automatically via PLC controls, or by direct manual operator observation and intervention. During this breakdown time period, in addition to introducing nitrogen, in order to further retard aluminum oxidation the burner firing rate can be reduced, and/or burner chemistry adjusted, and/or the furnace rotation could be slowed, or stopped, or “jogged”.

By limiting the nitrogen injection to the roughly 10 minute breakdown period only, corresponding to the maximum aluminum oxidation time period, it is anticipated that the cost of the nitrogen will be outweighed by the value of the increased aluminum recovery (reduced melt losses).

For a typical rotary furnace, the anticipated nitrogen requirement may be roughly 20,000 SCFH. This is roughly equivalent to the oxygen requirement for an oxy/gas burner firing at 10 MMBTU/hr, which is a common burner size for a rotary aluminum melt furnace. The additional 20,000 SCFH nitrogen would significantly dilute the CO2, H2O and any excess oxygen concentration in the furnace atmosphere, globally. But more importantly, since the nitrogen is injected underneath the burner, and directly above the aluminum surface, the local CO2, H2O and oxygen dilution effect directly at the aluminum surface should be much greater. A “perfect” nitrogen concentration at the aluminum surface would not be anticipated; however, a significant reduction in CO2, H2O and O2 content at the aluminum surface can be expected, thus reducing aluminum oxidation.

Lower or higher flow rates of nitrogen could be utilized, based on the specific furnace size, firing rate, configuration, type of scrap materials or other process considerations, to determine the optimum economics (aluminum recovery improvement vs. nitrogen cost).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A gas inerting system, comprising:
a rotary melting furnace comprising a furnace barrel, a burner, and a charge of metal to be melted; and
an inert gas injection manifold with a plurality of injection orifices;
wherein the burner is configured to produce a flame directed into the furnace barrel,
wherein the plurality of injection orifices are configured to disperse inert gas streams into the furnace barrel, into an inerting region between the burner flame and the charge of aluminum.

2. The system of claim 1, wherein the metal to be melted is aluminum.

3. The gas inerting system of claim 1, wherein the injection manifold has a semicircular shape, wherein the plurality of injection orifices is generally equidistant from the burner.

4. A method of inerting, utilizing the system of claim 1, the method comprising:
rotating the rotary furnace and introducing heat into the furnace barrel by generating the flame, thereby beginning a melt cycle,
introducing the inert gas streams into an inlet to the injection manifold, thereby directing the inert gas streams through the injection orifices and into the inerting region, after a predetermined condition has been met.

5. The method of claim 4, wherein the predetermined condition is selected from the group consisting of:
at the start of a breakdown phase,
at a predetermined time after the beginning of the melt cycle, and
at a predetermined time prior to the end of the melt cycle.

6. The method of claim 4, wherein the predetermined time prior to the end of the melt cycle is 10 minutes.

7. The method of claim 4, wherein the start of the breakdown phase may be identified by a factor selected from the group consisting of:
a change in the current drawn by the rotation motor,
a change in the flue gas temperature,
a change in the total cumulative BTU energy input per pound of charge,
determined by the programmable logic controller,
operator observation.

8. The method of claim 4, wherein:
the rate at which the heat is introduced into the furnace barrel is determined by a burner firing rate,
the burner comprises an oxidizer ratio, and
the furnace barrel comprises a rotation rate,
wherein, during the breakdown phase one or more actions may be taken, the actions are selected from the group consisting of:
the burner firing rate may be changed,
the burner oxidizer ratio may be changed,
the barrel rotation rate may be slowed,
the barrel rotation rate may be jogged, and
the barrel rotation rate may be stopped.
